(19) United States
(12) Patent Application Publication
(10) Pub. No.: US 2003/0023903 A1
(43) Pub. Date: Jan. 30, 2003

(54) Apparatus with diagnosis function and control system using the same

(76) Inventor: Yasuo Kumeda, Tokyo (JP)

Correspondence Address: VENABLE, Post Office Box 34385, Washington, DC, 20043-9998, US

(21) Appl. No.: 10/201,906

(22) Filed: Jul. 25, 2002

(30) Foreign Application Priority Data
Jul. 27, 2001 (JP) 2001-227265

(51) Int. Cl. H04L 1/22

(52) U.S. Cl. 714/25

(57) ABSTRACT

For obtaining diagnosis information, as well as in use of digital communication, at low cost with no need for special hardware and software, in a control system of conventional analog input-output type, a positioner executes control of a valve and other predetermined functions based on an analog input signal received through analog communication with an outside controller. It has an arithmetic processing unit for diagnosing abnormality of either or both of the positioner itself and the valve, and an analog diagnosis signal transmitter for transmitting an analog signal (4-20 mA) indicating result of diagnosis. The analog signal has a value of range corresponding to the result of diagnosis.

### FIELD OF THE INVENTION

The present invention relates to an apparatus that have diagnosis function and can inform of diagnosis information to an outside equipment such as superior controller, and also relates to a control system using the apparatus.

### BACKGROUND ART

As the apparatus having function to transmit the diagnosis information to a superior apparatus such as controller, and other outside equipment or system, there is a positioner disclosed in Japanese Patent Laid-Open No. 1-141202. As the positioner informs the outside equipment by way of communication path of diagnosis result of a valve, the outside equipment or system can analyzes the diagnosis result and take a measure to respond the result. As the communication path, it is general to use digital communication such as field bus to allow inform of details of the diagnosis result. According to the digital communication, the information including the diagnosis result can be sent precisely and rapidly.

Currently a controller used most commonly in a control system of plant uses an analog signal of 4-20 mA for input-output. Therefore, it is necessary to arrange a digital communication interface in the controller side in order to communicate the diagnosis information from the positioner to the controller by means of digital signal. Such interface is high-priced in comparison with analog type. Generally it may neither be spread nor specifications of communication are unified. That is, since the information from the apparatus such as conventional positioners having the diagnosis function is sent as digital signals in the form being not standardized, special hardware and software are necessary in the side using the information. Accordingly, in the existing controller, there is a problem that the diagnosis function of such positioner cannot be used by itself

### SUMMARY OF THE INVENTION

It is an object of the present invention to provide the apparatus that allows to obtain the diagnosis information, as well as in use of digital communication, at low cost with no need for special hardware and software, in a control system of conventional analog input-output type.

The first embodiment of the present invention is an apparatus executing control of a controlled element (for example, regulating valve) based on a command signal received through analog communication with an outside system, and other predetermined functions. The apparatus comprises a diagnosis unit to diagnose abnormality of either or both of the apparatus itself and the controlled element, and an analog signal transmitter for transmitting an analog signal indicating the diagnosis result.

The second embodiment is an apparatus having the function for transmitting a measurement result of a measurement object (for example, flow rate) through analog communication an the outside system. The apparatus comprises a diagnosis unit for diagnosing abnormality of either or both of the apparatus itself and the measurement object, and an analog signal transmitter for transmitting an analog signal indicating the diagnosis result.

In the apparatus according to the first or second above embodiment, for example, an output signal sent from the analog signal transmitter indicating the diagnosis result has a predetermined value corresponding to the diagnosis result, the value being changed discretely corresponding to the diagnosis result. Otherwise, the output signal has a value changing correspondingly to a degree of malfunction or normality when the diagnosis result is malfunction or normal.

The present invention further provides a control system that can process various diagnosis signals detected by the apparatus in combination of the apparatus of the first or second embodiment and a conventional analog type control system.

According to the present invention, the diagnosis result for the apparatus itself such as valve positioner, the controlled object controlled thereby, or the apparatus to become measurement object (for example, existence of abnormality or not, and degree of abnormality if any), is communicated in the form of analog signal (4-20 mA) usually used as input-output of the controller or the other control units side. Therefore, hardware and software to be special in the control unit side are not needed.

In the side of control unit, if alarm will be set near a maximum value or a minimum value of discrete value indicating the diagnosis result, when any abnormality is sent as the diagnosis information, the abnormality is informed to an operator by a standard alarm function of the control unit. In this way, without any need for special equipment, the diagnosis information of the apparatus will be available in the existing control system.

### BRIEF DESCRIPTION OF DRAWINGS

FIG. 1 shows general constitution of a control system that controls flow of fluid by a controller;

FIG. 2 shows constitution of a positioner used in the control system of FIG. 1;

FIG. 3 is a flow chart showing a processing procedure of the valve control and abnormality detection by the positioner of FIG. 2;

FIG. 4 shows an example of analog signal output from an analog diagnosis signal transmitter; and

FIG. 5 shows constitution of a flow rate transmitter used in the control system of FIG. 1.

### PREFERABLE EMBODIMENTS OF THE INVENTION

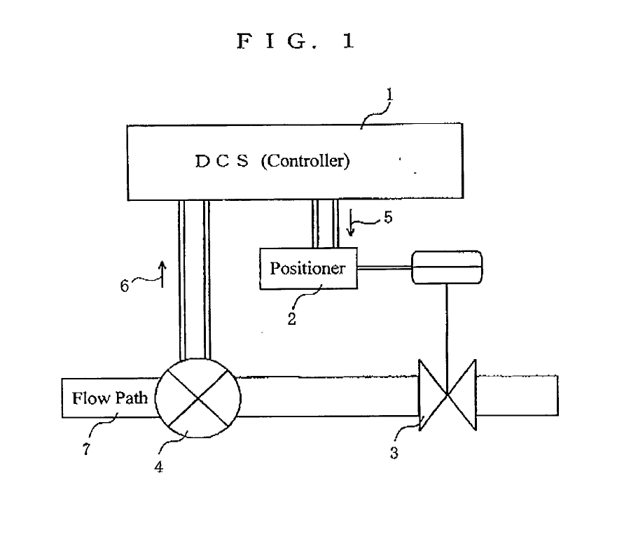

FIG. 1 shows outline constitution of the control system which controls flow rate of fluid in a plant by controller as an embodiment of a system using the apparatus of the present invention.

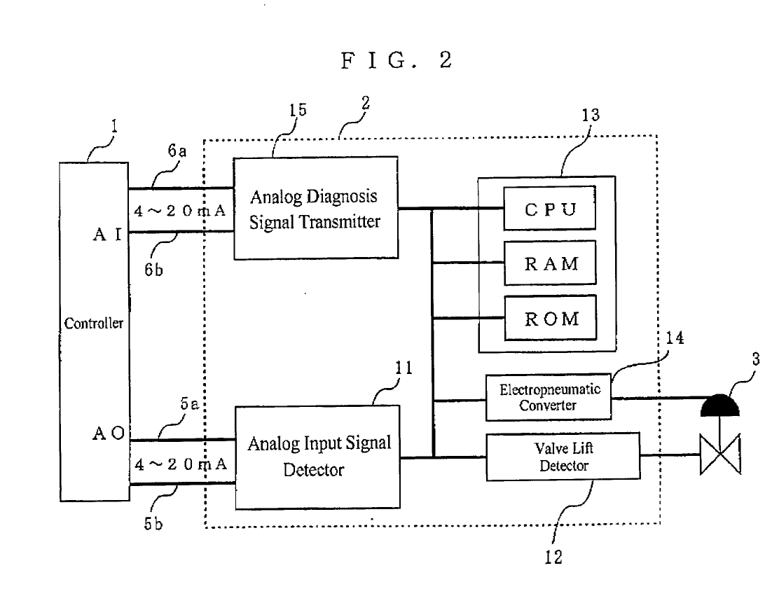

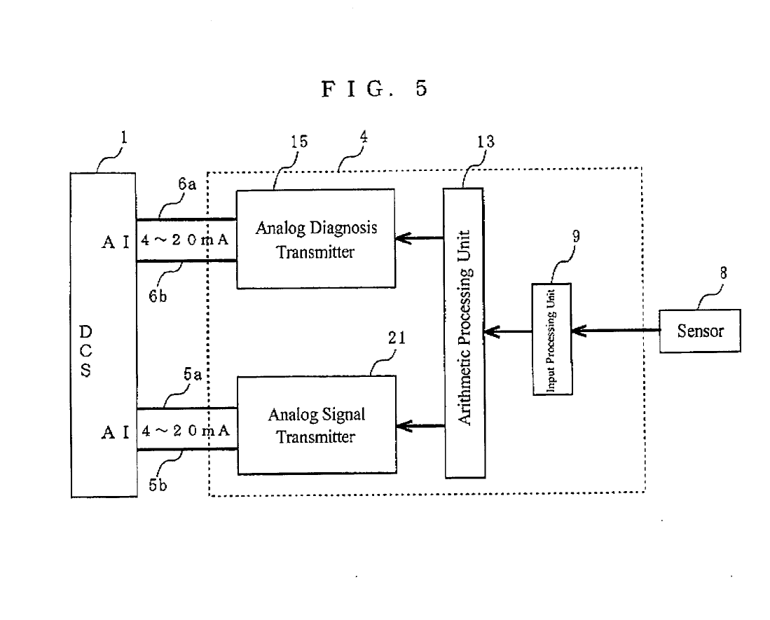

In this control system, a superior controller (DCS) 1 changes a flow rate control signal 5 based on a flow rate signal 6 sent from a flow rate transmitter 4, a valve divergence of valve (regulation valve) 3 is regulated and a flow rate passed in a flow path 7 is regulated. A positioner 2 is used to regulate the valve divergence of valve 8 adequately. On the other hand, the positioner 2 or the flow rate transmitter 4 has function to diagnose the apparatus itself and devices connected thereto, or a process, and it can inform DCS 1 of the diagnosis result. The constitution of such as positioner 2 is shown in FIG. 2, and the constitution of flow rate transmitter 4 is shown in FIG. 5.

In FIG. 2, the positioner 2 has a positioning function to control the valve position of valve 3 corresponding to the command signal from the controller 1. Therefore, the positioner 2 includes an analog input signal detector 11 that converts the analog signal (4-20 mA) sent through the analog signal transmission channel consisting of two track lines 5a, 5b from an output port AO of the controller 1 to the digital signal; a valve lift detector 12 to detecting the valve lift of valve 3; an arithmetic processing unit 13 for predetermined arithmetic processing based on the signal from the analog input signal detector 11 and outputting pulsed signal (that gives the valve lift) for controlling a drive unit of valve 3; an electropneumatic converter 14 for converting the pulsed signal output from the arithmetic processing unit 13 to an air pressure signal and for supplying it to the drive unit of regulation valve 3; and an analog diagnosis signal transmitter 15 for transmitting analog signal indicating the diagnosis result.

The analog input signal detector 11 includes an electric current/pulse converter that converts an electric current signal of above 4-20 mA to pulsed signal. The analog diagnosis signal transmitter 15 includes the pulse/electric current converter that converts the electric current signal of 4-20 mA to the pulsed signal. This analog diagnosis signal transmitter 15 is connected through the analog signal transmission channel consisting of two track lines 6a, 6b to an input port AI of the controller 1. The analog signal transmission channel transmits the signal (4-20 mA) indicating diagnosis result transmitted from the positioner 2, as will be mentioned later.

The valve lift detector 12 includes the position/pulse converter that converts stem displacement to show divergence of valve 3 to the pulsed signal. The electropneumatic converter 14 includes the pulse/air pressure converter that converts the valve lift control signal output as the pulsed signal (correction signal) from the arithmetic processing unit 13 to an air pressure signal.

The arithmetic processing unit 13 consist of a microprocessor (CPU) executing the operation of control and abnormality detection as mentioned later, a ROM that stores the operation program executed by the CPU, and a RAM that stores various parameters for use in the operation. The arithmetic processing unit 13 executes arithmetic operation as positioner that takes a deviation of the input signal from the analog input signal detector 11 and the valve lift signal from the valve lift detector 12, and produces a valve lift control signal corresponding to the deviation Further, the arithmetic processing unit 13 has the function as diagnosis unit that diagnoses the state of valve 3 or positioner 2 itself and that outputs the diagnosis result, in addition to the function to control the operation as positioner. The diagnosis unit diagnoses the following abnormal conditions:

(a) Abnormal friction in packing of the valve and the valve shaft sliding unit, intermeshing of foreign substance in the valve, abnormality of fluid counterforce, valve drive unit MP leak, and the like, as abnormality of relation between the valve lift of valve 3 and the air pressure output from the positioner 2.

(b) Abnormality of supply air pressure, insufficient operation of the positioner, and the like, as abnormality of relation between the deviation signal (difference between the input signal from input signal detector 11 and the valve lift signal from valve lift detector 12) and the air pressure output.

(c) A fluid leak from the packing of valve 3.

(d) Abnormality of deviation between the input signal from input signal detector 11 and the valve lift signal from valve lift detector 12 (when the deviation in equilibrium is over a permission level).

(e) When jerking-motion (phenomenon in which signal changes jerkily and valve becomes prognostic of meshing) occurred to the valve lift signal.

In the above-mentioned constitution, the direct current signal of 4-20 mA is transmitted and received between the controller 1 and the analog input signal detector 11, while electric power to drive the positioner 2 is supplied via the same track lines 5a, 5b from the controller 1. As the analog input signal detector 11, a receiver device (Japanese Patent Laid-Open No. 60-257629) according to a patent application by the applicant can be used.

For example, when this positioner is used in the process of FIG. 1, the controller 1 carries out PID operation so that flow rate of fluid comes to a value (set value) that the operator set. The result of arithmetic operation is transmitted to the positioner 2 as a valve divergence instruction signal by the electric current of 4-20 mA. In the positioner 2, the valve divergence instruction signal that is converted to the pulse signal by the analog input signal detector 11 under control in the arithmetic processing unit 13, is sent to the electropneumatic converter 14 and converted to the air pressure signal to drive the valve 3. Then, the CPU executes the control to arrive at stability in valve divergence of target by watching practical valve divergence that is detected by the valve lift detector 12.

When all is normal, the valve 3 may reach to the divergence instructed by the controller 1 within regular time, and maintain the divergence unless the set value is changed afterward. However, if abnormality of air leaks or dragging of the valve shaft occurs in a drive system of the valve, it will result in a difference between set valve divergence and practical valve divergence. While the arithmetic processing unit 13 recognizes the set valve divergence, it obtains the practical valve divergence from the valve lift detector 12, and therefore, a difference between both valve divergences will inform the occurrence of abnormality.

When the arithmetic processing unit 13 detects the abnormal conditions as mentioned above, the pulsed signal indicating the abnormal condition is converted to the electric current signal in the above analog diagnosis signal transmitter 15, and it is sent to the controller 1 and other super devices. The abnormality can be detected in a wide diagnosis by using air pressure sensor, a supersonic wave sensor or a temperature sensor and the like installed outside, as well as the abnormality of signal is detected in the arithmetic processing Part 13.

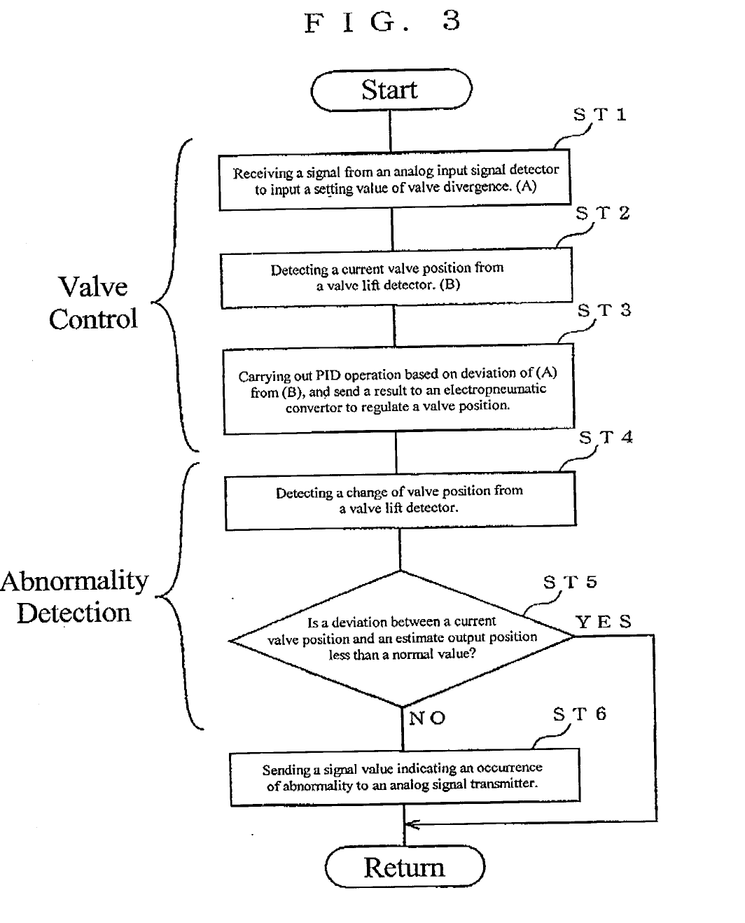

FIG. 3 is a flow chart that shows the processing procedure of operation of the valve control and abnormality detection executed by the arithmetic processing unit 13.

At the beginning, the CPU inputs a set value of valve divergence (A) from an analog input signal detector 11 and storing in RAM (ST1). On the other hand, a current valve position (B) is inputted from the valve lift detector 12 and stored in RAM (ST2). The PID operation is carried out based on a deviation of (A) from (B), and a result is sent to the electropneumatic converter 14 as the valve lift control signal to regulate the valve position (ST3). The above is the operation of valve control as the positioner.

Next, the CPU detects a change of valve position from the valve lift detector 12 (ST4). Also, it judges whether there is a difference (deviation) between a current valve position and an estimate output position (the valve position that is regulated with the control signal of ST3) less than a normal value (ST5). As a result, if there is the above deviation less than a normal value, it comes back to the beginning. If there is the deviation more than a normal value, it judges as abnormality and outputs a signal indicating the occurrence of abnormality (ST6), and it comes back to the beginning. The above is the operation of abnormality detection.

Though the diagnosis of valve may be classified in accordance with any kind of abnormality detected, it is assumed hereinafter that two kinds of abnormalities are detected in this embodiment. They will be called “abnormality 1” and “abnormality 2”. When “abnormality 1” and “abnormality 2” may not be detected simultaneously, the positioner of the embodiment has either state of “normal”, “abnormality 1 occurrence”, or “abnormality 2 occurrence”.

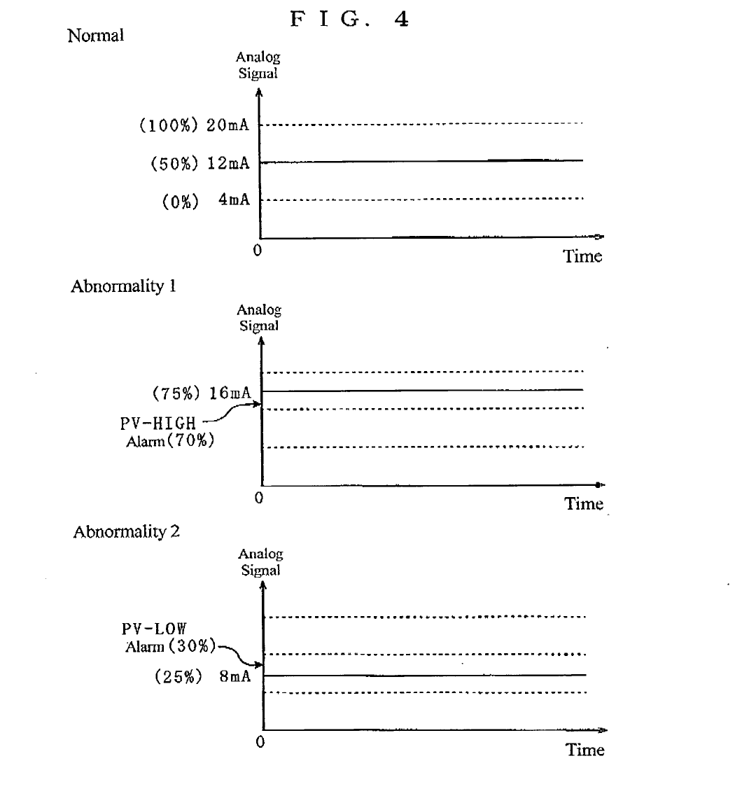

In this embodiment, three states are indicated by the analog signal from the analog diagnosis signal transmitter 15. For example, as shown in FIG. 4, it occurs with the analog output of 12 mA (50%) in the “normal” state. Further, the output is changed into 15.2-16.8 mA (70%-80%) in “abnormality 1 occurrence” state, and the output is changed into 8.8-7.2 mA (30%-20%) in “abnormality 2 occurrence” state, respectively. In this case, the abnormality condition is informed by the analog output of normal state (50%) changing with discrete of 20% in a plus (+) or a minus (−) direction.

Here, the case when “abnormality 1” is detected will be considered. In a normal state, the arithmetic processing unit 13 generates the pulsed signal that is necessary in order to output the electric current signal of 12 mA from the analog diagnosis signal transmitter 15. When “abnormality 1” is detected, the arithmetic processing unit 13 generates the pulsed signal that it is necessary in order to output the electric current signal of 16 mA from the analog diagnosis signal transmitter 15. The notification when abnormality is detected is also given quite similarly, but the electric current signal of the center value 8 mA is transmitted from the analog diagnosis signal transmitter 15. The alarm is set in the predetermined electric current value about the input of the diagnosis result notification signal. Therefore, upon receipt of the electric current signal of 16 mA or 8 mA, the alarm occurs and the operator is informed of the occurrence of “abnormality”.

Further, in the above examples, since the degree of abnormal can be indicated in a width of 10% of the diagnosis result notification signal, the abnormal condition can be informed more finely, for example, by normalizing and sending the degree of “abnormality 1” to the output change (15.2-16.8 mA) of 10% of the diagnosis result notification signal.

As practical examples of “abnormality 1” and “abnormality 2”, other than a difference between the set value and the practice value of valve divergence, there are time until the valve divergence reaches the set value, numbers of coming and going times or moving distance of the valve, or diagnoses of wider range that can be realized by addition of measuring instruments outside, and the like. In any case, the diagnosis result can be informed only by the analog signal of 4-20 mA that is used most commonly in a field of process control.

It is enough to have a usual analog input terminal (AI) in order to utilize the diagnosis function of the positioner 2 in the side of controller 1. For example, “PV alarm” is set in the Al. As shown in FIG. 4, if the PV-HIGH alarm is set in 70% (15.2 mA) and the PV-LOW alarm is set in 30% (8.8 mA), the alarm does not occur. because the output in the “normal” state is 50%, When “abnormality 1” is detected by the valve diagnosis function, the analog diagnosis signal transmitter 15 sets analog output more than 70% based on instructions of the arithmetic processing unit 13. Therefore the alarm is detected as the PV-HIGH alarm in the side of outside control system 1. Thus, an operator can recognize the abnormality of the valve in the same way as in the usual alarm. The “abnormality 2” state is also notified quite similarly.

Though there are two kinds of abnormalities of the valve in the above-mentioned example, it can be increased theoretically as many as by selection of width of discrete value range such as the above. Further, in case where several abnormalities occur simultaneously, an order of priority is set in the abnormalities, and the discrete values of analog outputs are assigned in the order, thus the abnormality of top priority is always informed. Since a plurality of alarms can be set for one analog input in a general DCS, if the above method is used, then it is possible to use a usual analog input to process a plurality of 1 valve diagnosis results.

By the way, since the valve is driven to open or close against the counterforce of fluid passing through the valve when the positioner regulates divergence of the valve 3, there is a difference in leeway of the electropneumatic converter 14 even if objective valve divergence is obtained. In the above description, when the positioner Or controlled object works normally, it is assumed that the positioner output a fixed value of 50% to the track lines 6a, 6b. However, if the output of the normal state is changed, between 40%/a and 60%, for example, and this output range corresponds to the leeway degree, then it is possible to inform by how much leeway the positioner controls the valve divergence to the superior controller 1.

Next, FIG. 5 shows constitution of flow rate transmitter 4. Here, though the flow rate transmitter is described as an example, various transmitters such as pressure or temperature transmitter can be described quite similarly.

In FIG. 5, the flow rate value measured by the flow rate sensor 8 is converted to the digital signal in the input processing unit 9, and it is sent to the arithmetic processing unit 13. The arithmetic processing unit 13 carries out setting of range and conversion to an industrial standard unit as for the input from the sensor 8, and transmits it as the analog input signal of 4-20 mA from the analog signal transmitter 21 to the DCS 1. Further, the arithmetic processing unit 13 detects the abnormal states of the sensor from time series changes of the signal inputted from the sensor 8, and transmitted the result as the analog diagnosis signal of 4-20 mA from the analog diagnosis signal transmitter 15 to the DCS 1. In addition, as an alternative embodiment, it is possible to diagnose the sensor and the process based on information from another sensor not shown, and to transmitted the result from the analog diagnosis signal transmitter 15.

The signal output from the analog diagnosis signal transmitter 15 is a usual 4-20 mA signal and can be received by usual DCS 1. Further, the signal form is quite the same as in the case the positioner explained referring to FIG. 2.

1. An apparatus for executing control of a controlled element and other predetermined functions based on a command signal received through analog communication with an outside system, which comprises:
a diagnosis unit to diagnose abnormality of either or both of the apparatus itself and the controlled element; and
an analog signal transmitter for transmitting an analog signal indicating the diagnosis result.

2. An apparatus having function for transmitting a measurement result of measurement object through analog communication with an outside system, which comprises:
a diagnosis unit for diagnosing abnormality of either or both of the apparatus itself and the measurement object; and
an analog signal transmitter for transmitting an analog signal indicating the diagnosis result.

3. The apparatus according to claims 1 or 2, wherein an output signal sent from the analog signal transmitter has a value of range corresponding to the diagnosis result.

4. The apparatus according to claim 3, wherein the output signal has discrete values corresponding to the diagnosis result.

5. The apparatus according to claim 3, wherein the output signal has a value changing correspondingly to a degree of malfunction when the diagnosis result is malfunction.

6. The apparatus according to claim 3, wherein the output signal has a value changing correspondingly to a degree of normality when the diagnosis result is normal.

7. A control system which comprises the apparatus according to any one of claims 1 to 6 and a control unit for controlling the apparatus, the control unit having an analog input means for receiving analog signal as diagnosis signal from the apparatus.
